(19) United States
(12) Patent Application Publication
(10) Pub. No.: US 2005/0139303 A1
(43) Pub. Date: Jun. 30, 2005

(54) Low internal pressure pneumatic tire

(76) Inventor: Kazuhiro Hirose, Kobe-shi (JP)

Correspondence Address: BIRCH STEWART KOLASCH & BIRCH, PO BOX 747, FALLS CHURCH, VA, 22040-0747, US

(21) Appl. No.: 10/944,819

(22) Filed: Sep. 21, 2004

(30) Foreign Application Priority Data
Dec. 25, 2003 (JP) 2003-428756

(51) Int. Cl. B60C 11/11

(52) U.S. Cl. 152/209.15

(57) ABSTRACT

A tread (11) of a tire (10) is provided with a plurality of blocks (12) to (15). The blocks (12) to (15) are provided symmetrically about an equator plane (E). Each of the blocks (12) to (15) is provided regularly in a circumferential direction. Each of the blocks (12) to (15) is formed to take a solid shape specified by a long side dimension (W), a short side dimension (L) and a high side dimension (H). The blocks (12) to (15) include recesses (21), (24), (27) and (28) respectively. Each of the recesses (21), (24), (27) and (28) is specified by a long side dimension (WR), a short side dimension (LR) and a deep side dimension (HR). The dimensions have a relationship of WR/W=0.33 to 0.87, LR/L=0.2 to 0.8 and HR/H=0.15 to 0.85. A ratio of a block volume (BT) to a recess volume (RT) is set to be RT/BT=0.08 to 0.25.

This application claims priority on Patent Application No. 2003-428756 filed in Japan on Dec. 25, 2003.

### BACKGROUND OF THE INVENTION

1. Field of the Invention

The present invention relates to a structure of a pneumatic tire of a low internal pressure type. The pneumatic tire of this type is employed for a buggy running over a rough road such as an uneven ground and other ATVs (All Terrain Vehicles).

2. Description of the Related Art

In general, a tire to be employed for a vehicle is to have a traction performance and a sliding performance. The traction performance realizes a high straight running stability for a vehicle. The sliding performance implies a cornering response performance during steering. The sliding performance realizes a high cornering stability for a vehicle. For example, a tire to be employed for an ATV is to have an excellent traction performance and sliding performance for a rough road such as an uneven ground. Usually, the tire for the ATV is a pneumatic tire of a low internal pressure type. In the tire of this type, the tread portion of the tire is provided with a plurality of blocks in an erecting state along a tread surface.

In the tire for the ATV, conventionally, the external shape of the block, the way of an array, the depth of a groove formed between the blocks and the like are set corresponding to the specification of the tire. The combination of these elements causes the traction performance and the sliding performance to be consistent with each other. Consequently, the expected object of the tire for the ATV can be achieved. Japanese Laid-Open Patent Publications Nos. 2002-362113 and Hei 1-148606 have described the foregoing.

In recent years, the output of an engine to be mounted on an ATV has been increased and the weight of the ATV has also been increased. For this reason, the tire for the ATV has been demanded to maintain a high traction performance and sliding performance at a high load.

In the case in which the performance of the tire for the ATV is to be maintained by a conventional method, however, the following problem arises. As a result, an expected performance cannot be achieved. More specifically, in the case in which the external shape of a block is large, for example, a traction performance is enhanced and a control performance is deteriorated. On the other hand, in the case in which the external shape of the block is small, a sliding performance is enhanced and the traction performance is deteriorated. In the case in which the external shape of the block is small and the depth of a groove formed between the blocks is great, both the traction performance and the sliding performance tend to be enhanced and the weight of the tire is increased. The increase in the weight of the tire deteriorates a ride comfort, and furthermore, lowers a running performance (a straight running stability, a cornering stability and the like).

### SUMMARY OF THE INVENTION

The present invention has been made in such a background. It is an object of the present invention to provide a low internal pressure pneumatic tire which suppresses a deterioration in a running performance and enhances a traction performance and a sliding performance.

The low internal pressure pneumatic tire according to the present invention is used for running over an uneven ground. A plurality of blocks is provided on a tread. Each of the blocks is formed to be protruded outward in the radial direction of the tire. Each of the blocks is formed to take a solid shape specified by a long side dimension W, a short side dimension L and a high side dimension H. The outer peripheral surface of each block forms a tread surface. The outer peripheral surface of each block is provided with a recess specified by a long side dimension WR, a short side dimension LR and a deep side dimension HR.

The dimensions have the following relationship:
WR/W=0.33 to 0.87,
LR/L=0.2 to 0.8, and
HR/H=0.15 to 0.85.

A ratio of a block volume BT to a recess volume RT is set to be RT/BT=0.08 to 0.25.

Thus, the relative size of the recess with the block is set. When the low internal pressure pneumatic tire rolls over a road surface, consequently, each block is deformed properly so that a grip force is generated. The grip force enhances a traction performance and a sliding performance. In addition, an increase in the weight of the low internal pressure pneumatic tire is suppressed so that a running performance can be prevented from being deteriorated.

### BRIEF DESCRIPTION OF THE DRAWINGS

FIG. 1 is an enlarged front view showing the main part of a tire according to an embodiment of the present invention,

FIG. 2 is an enlarged view showing the tread of the tire according to the embodiment of the present invention,

FIG. 3 is a sectional view taken along III-III in FIG. 2, and

FIG. 4 is a sectional view taken along IV-IV in FIG. 2.

### DESCRIPTION OF THE PREFERRED EMBODIMENTS

The present invention will be described below in detail based on a preferred embodiment with reference to the drawings.

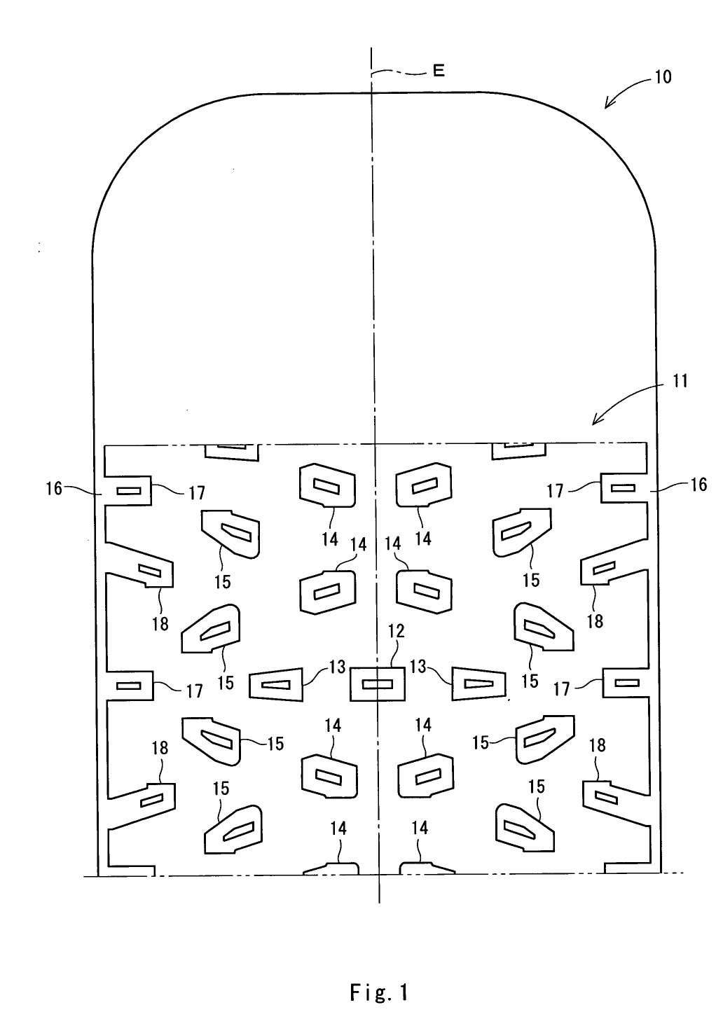

As shown in FIG. 1, a low internal pressure pneumatic tire (hereinafter referred to as a “tire”) 10 according to the embodiment of the present invention is used for running over an uneven ground and is employed for an ATV or the like, for example. The tire 10 has a well-known internal structure and is manufactured by a well-known method. The tire 10 has a carcass constituting a frame, a reinforcing layer for reinforcing the carcass, and a tread 11 formed to cover the reinforcing layer. The tire 10 according to the present embodiment features the structure of the tread 11. Since the tread 11 has the following structure, the tire 10 exhibits an excellent traction performance and sliding performance. In FIG. 1, a transverse direction is set to be an axial direction and a direction of an equator plane E is set to be a radial direction.

The tread 11 is formed symmetrically about the equator plane E. The tread 11 is provided with a plurality of blocks 12 to 15 in a circumferential direction. Each of the blocks 12 to 15 is continuously formed symmetrically about the equator plane E and regularly. Each of the blocks 12 to 15 is formed to take a solid shape. The block 12 is formed like a rectangular parallelepiped and the blocks 13 to 15 have sections formed like polygonal columns. Indeed, the shapes of the blocks 12 to 15 are not restricted thereto but can be designed and changed properly corresponding to the specification of the tire.

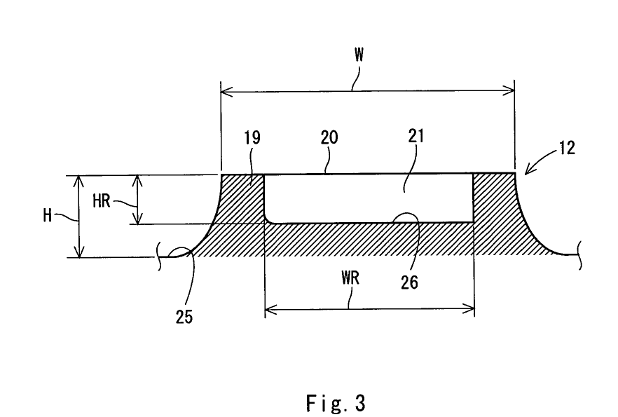

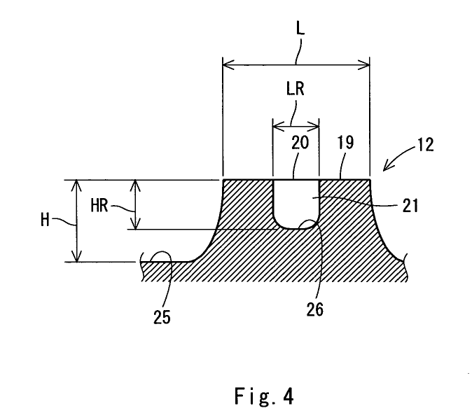

As shown in FIGS. 3 and 4, the block 12 has a long side dimension W set to be 25 mm to 35 mm, a short side dimension L set to be 15 mm to 25 mm and a high side dimension H set to be 10 mm to 15 mm. The high side dimension H represents a distance from a tread surface 25 to an upper surface 19 of the block 12. Each of the dimensions W, L and H can be designed and changed properly corresponding to the specification of the tire.

The block 12 includes a recess 21 having an opening 20. The opening 20 is provided on the upper surface 19 of the block 12. The recess 21 has a long side dimension WR set to be 10 mm to 20 mm, a short side dimension LR set to be 2 mm to 4 mm and a deep side dimension HR set to be 2 mm to 4 mm. The deep side dimension HR represents a distance from an internal bottom surface 26 of the recess 21 to the upper surface 19 of the block 12. The recess 21 is formed with an internal wall surface taking an almost U shape as shown in FIG. 4. It is a matter of course that the shape of the internal wall surface of the recess 21 is not restricted thereto.

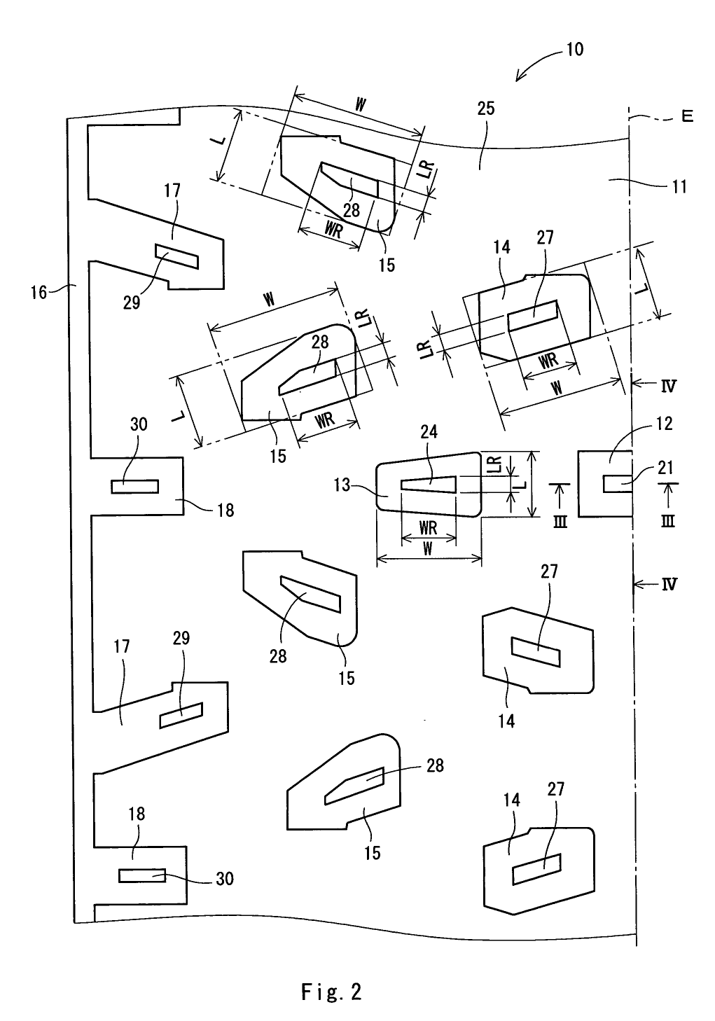

The block 13 is formed to be almost wedge-shaped as shown in FIGS. 1 and 2. The block 13 has a long side dimension W set to be 24 mm to 34 mm, a short side dimension L set to be 10 mm to 20 mm and a high side dimension (H) set to be 12 mm to 17 mm. The high side dimension (H) is not shown in these drawings and represents a distance from the tread surface 25 to the upper surface of the block 13 in the same manner as in the block 12. Referring to the block 13, similarly, each of the dimensions W, L and H can be designed and changed properly corresponding to the specification of the tire.

The block 13 also includes a recess 24 having an opening. The recess 24 has a long side dimension WR set to be 20 mm to 30 mm, a short side dimension LR set to be 2 mm to 3 mm and a deep side dimension (HR) set to be 1 mm to 2 mm. The deep side dimension (HR) is not shown in these drawings and represents a distance from the internal bottom surface of the recess 24 to the upper surface of the block 13 in the same manner as in the block 12. The recess 24 is formed with an internal wall surface taking an almost U shape in the same manner as the recess 21. However, the shape of the internal wall surface of the recess 24 is not restricted thereto.

The block 14 has a section formed like a polygonal column as shown in FIGS. 1 and 2. The block 14 has a long side dimension W set to be 30 mm to 40 mm, a short side dimension L set to be 15 mm to 25 mm and a high side dimension (H) set to be 12 mm to 17 mm. The high side dimension (H) is not shown in these drawings and represents a distance from the tread surface 25 to the upper surface of the block 14 in the same manner as in the block 12. The long side dimension W of the block 14 is shown in FIG. 2. More specifically, in the case in which the presence of a virtual rectangle surrounding the block 14 is assumed, the length of the long side of the virtual rectangle is equal to the long side dimension W. In the virtual rectangle, the upper and lower sides of the block 14 make a pair of opposed sides. On the other hand, the short side dimension L of the block 14 is equal to the length of the short side of the virtual rectangle. Referring to the block 14, similarly, each of the dimensions W, L and H can be designed and changed properly corresponding to the specification of the tire.

The block 14 also includes a recess 27 having an opening. The opening is provided on the upper surface of the block 14. The recess 27 has a long side dimension WR set to be 10 mm to 20 mm, a short side dimension LR set to be 1 mm to 2 mm and a deep side dimension (HR) set to be 1 mm to 2 mm. The deep side dimension (HR) is not shown in these drawings and represents a distance from the internal bottom surface of the recess 27 to the upper surface of the block 14 in the same manner as in the block 12. The recess 27 is formed with an internal wall surface taking an almost U shape in the same manner as the recess 21. However, the shape of the internal wall surface of the recess 27 is not restricted thereto.

The block 15 has a section formed like a polygonal column as shown in FIGS. 1 and 2. The block 15 has a long side dimension W set to be 30 mm to 40 mm, a short side dimension L set to be 15 mm to 25 mm and a high side dimension (H) set to be 10 mm to 15 mm. The high side dimension (H) is not shown in these drawings and represents a distance from the tread surface 25 to the upper surface of the block 15 in the same manner as in the block 12. The long side dimension W and the short side dimension L of the block 15 are defined in the same manner as those of the block 14. More specifically, in the case in which the presence of a virtual rectangle surrounding the block 15 is assumed, the length of the long side of the virtual rectangle is equal to the long side dimension W. In the virtual rectangle, the upper and lower sides of the block 15 make a pair of opposed sides. On the other hand, the short side dimension L of the block 15 is equal to the length of the short side of the virtual rectangle. Referring to the block 15, similarly, each of the dimensions W, L and H can be designed and changed properly corresponding to the specification of the tire.

The block 15 also includes a recess 28 having an opening. The opening is provided on the upper surface of the block 15. The recess 28 has a long side dimension WR set to be 10 mm to 20 mm, a short side dimension LR set to be 1 mm to 2 mm and a deep side dimension (HR) set to be 1 mm to 2 mm. The deep side dimension (HR) is not shown in these drawings and represents a distance from the internal bottom surface of the recess 28 to the upper surface of the block 15 in the same manner as in the block 12. The recess 28 is formed with an internal wall surface taking an almost U shape in the same manner as the recess 21. However, the shape of the internal wall surface of the recess 28 is not restricted thereto.

A shoulder portion 16 of the tire 10 is also provided with blocks 17 and 18. The blocks 17 and 18 are provided continuously in a circumferential direction. The blocks 17 and 18 are provided alternately. The block 17 has a recess 29 and the block 18 has a recess 30.

Referring to each of the blocks 12 to 15, the long side dimension W, the short side dimension L, the high side dimension H, the long side dimension WR, the short side dimension LR and the deep side dimension HR have the following relationship. More specifically, there are set
WR/W=0.33 to 0.87,
LR/L=0.2 to 0.8, and
HR/H=0.15 to 0.85.
There are preferably set
WR/W≧0.40, WR/W≦0.70,
LR/L≧0.30, LR/L≦0.60, and
HR/H≧0.20, HR/H≦0.70.
There are more preferably set
WR/W≧0.40, WR/W≦0.60,
LR/L≧0.30, LR/L≦0.50, and
HR/H≧0.20, HR/H≦0.60.

Referring to each of the blocks 12 to 15, furthermore, the ratio of a block volume BT to a recess volume RT is set to be
RT/BT=0.08 to 0.25.
The ratio is preferably set to be
RT/BT≧0.10, RT/BT≦0.20.
The ratio is more preferably set to be
RT/BT≧0.10, RT/BT≦0.17.

### EXAMPLES

The effects of the present invention will be apparent below by way of examples. The present invention should not be construed to be restricted based on the description of the examples.

Table 1 shows a result obtained by executing a comparison test for a conventional tire (comparative examples 1 to 5) for the handling stability of a tire according to each of examples 1 to 7 of the present invention.

The specification of the tire according to each of the examples and the comparative examples is a low internal pressure tire (AT22 10-10 KT857) for off-road use which is attached to a four-wheel buggy. The tire according to each of the examples and the comparative examples comprises a plurality of blocks. Each of the blocks is provided on a tread so as to be protruded outward in a radial direction. Each of the blocks includes a recess.

### Example 1

A block has a long side dimension W of 30 mm, a short side dimension L of 10 mm, a high side dimension H of 13 mm, a block volume BT of 3900 mm³, and a recess volume RT of 640 mm³. Moreover, a dimension ratio WR/W is set to be 0.67, a dimension ratio LR/L is set to be 0.4, a dimension ratio HR/H is set to be 0.62, and a volume ratio RT/BT is set to be 0.16.

### Example 2

A block has a long side dimension W of 30 mm, a short side dimension L of 10 mm, a high side dimension H of 13 mm, a block volume BT of 3900 mm³, and a recess volume RT of 400 mm³. Moreover, a dimension ratio WR/W is set to be 0.67, a dimension ratio LR/L is set to be 0.4, a dimension ratio HR/H is set to be 0.38, and a volume ratio RT/BT is set to be 0.10.

### Example 3

A block has a long side dimension W of 30 mm, a short side dimension L of 10 mm, a high side dimension H of 13 mm, a block volume BT of 3900 mm³, and a recess volume RT of 320 mm³. Moreover, a dimension ratio WR/W is set to be 0.33, a dimension ratio LR/L is set to be 0.4, a dimension ratio HR/H is set to be 0.62, and a volume ratio RT/BT is set to be 0.08.

### Example 4

A block has a long side dimension W of 30 mm, a short side dimension L of 10 mm, a high side dimension H of 13 mm, a block volume BT of 3900 mm³, and a recess volume RT of 960 mm³. Moreover, a dimension ratio WR/W is set to be 0.67, a dimension ratio LR/L is set to be 0.6, a dimension ratio HR/H is set to be 0.62, and a volume ratio RT/BT is set to be 0.25.

### Example 5

A block has a long side dimension W of 30 mm, a short side dimension L of 10 mm, a high side dimension H of 13 mm, a block volume BT of 3900 mm³, and a recess volume RT of 416 mm³. Moreover, a dimension ratio WR/W is set to be 0.87, a dimension ratio LR/L is set to be 0.8, a dimension ratio HR/H is set to be 0.15, and a volume ratio RT/BT is set to be 0.11.

### Example 6

A block has a long side dimension W of 30 mm, a short side dimension L of 10 mm, a high side dimension H of 13 mm, a block volume BT of 3900 mm³, and a recess volume RT of 572 mm³. Moreover, a dimension ratio WR/W is set to be 0.87, a dimension ratio LR/L is set to be 0.2, a dimension ratio HR/H is set to be 0.85, and a volume ratio RT/BT is set to be 0.15.

### Example 7

A block has a long side dimension W of 30 mm, a short side dimension L of 10 mm, a high side dimension H of 13 mm, a block volume BT of 3900 mm³, and a recess volume RT of 400 mm³. Moreover, a dimension ratio WR/W is set to be 0.33, a dimension ratio LR/L is set to be 0.8, a dimension ratio HR/H is set to be 0.38, and a volume ratio RT/BT is set to be 0.10.

### Comparative Example 1

A block has a long side dimension W of 30 mm, a short side dimension L of 10 mm, a high side dimension H of 13 mm, a block volume BT of 3900 mm³, and a recess volume RT of 160 mm³. Moreover, a dimension ratio WR/W is set to be 0.67, a dimension ratio LR/L is set to be 0.4, a dimension ratio HR/H is set to be 0.15, and a volume ratio RT/BT is set to be 0.04.

### Comparative Example 2

A block has a long side dimension W of 30 mm, a short side dimension L of 10 mm, a high side dimension H of 13 mm, a block volume BT of 3900 mm³, and a recess volume RT of 1280 mm³. Moreover, a dimension ratio WR/W is set to be 0.67, a dimension ratio LR/L is set to be 0.8, a dimension ratio HR/H is set to be 0.62, and a volume ratio RT/BT is set to be 0.33.

### Comparative Example 3

A block has a long side dimension W of 30 mm, a short side dimension L of 10 mm, a high side dimension H of 13 mm, a block volume BT of 3900 mm³, and a recess volume RT of 2288 mm³. Moreover, a dimension ratio WR/W is set to be 0.87, a dimension ratio LR/L is set to be 0.8, a dimension ratio HR/H is set to be 0.85, and a volume ratio RT/BT is set to be 0.59.

### Comparative Example 4

A block has a long side dimension W of 30 mm, a short side dimension L of 10 mm, a high side dimension H of 13 mm, a block volume BT of 3900 mm³, and a recess volume RT of 260 mm³. Moreover, a dimension ratio WR/W is set to be 0.87, a dimension ratio LR/L is set to be 0.2, a dimension ratio HR/H is set to be 0.38, and a volume ratio RT/BT is set to be 0.07.

### Comparative Example 5

A block has a long side dimension W of 30 mm, a short side dimension L of 10 mm, a high side dimension H of 13 mm, a block volume BT of 3900 mm³, and a recess volume RT of 50 mm. Moreover, a dimension ratio WR/W is set to be 0.17, a dimension ratio LR/L is set to be 0.2, a dimension ratio HR/H is set to be 0.38, and a volume ratio RT/BT is set to be 0.01.

The comparison test is carried out in the following procedure. More specifically, the tire according to each of the examples and the comparative examples is attached to a four-wheel buggy. A test driver synthetically judges a traction performance, a control performance and a ride comfort in the running of the four-wheel buggy and decides them to be excellent or bad.

TABLE 1

| | | | Com- | | Com- | | | Com- | | Com- | | Com- |
|---|---|---|---|---|---|---|---|---|---|---|---|---|
| | | | parative | | parative | | | parative | | parative | | parative |
| | Exam- | Exam- | Exam- | Exam- | Exam- | Exam- | Exam- | Exam- | Exam- | Exam- | Exam- | Exam- |
| | ple 1 | ple 2 | ple 1 | ple 3 | ple 2 | ple 4 | ple 5 | ple 3 | ple 6 | ple 4 | ple 7 | ple 5 |
| Long side | 30 | 30 | 30 | 30 | 30 | 30 | 30 | 30 | 30 | 30 | 30 | 30 |
| dimension | | | | | | | | | | | | |
| W (mm) | | | | | | | | | | | | |
| Short side | 10 | 10 | 10 | 10 | 10 | 10 | 10 | 10 | 10 | 10 | 10 | 10 |
| dimension | | | | | | | | | | | | |
| L (mm) | | | | | | | | | | | | |
| High side | 13 | 13 | 13 | 13 | 13 | 13 | 13 | 13 | 13 | 13 | 13 | 13 |
| dimension | | | | | | | | | | | | |
| H (mm) | | | | | | | | | | | | |
| Block | 3900 | 3900 | 3900 | 3900 | 3900 | 3900 | 3900 | 3900 | 3900 | 3900 | 3900 | 3900 |
| volume | | | | | | | | | | | | |
| BT | | | | | | | | | | | | |
| Recess | 640 | 400 | 160 | 320 | 1280 | 960 | 416 | 2288 | 572 | 260 | 400 | 50 |
| volume | | | | | | | | | | | | |
| RT | | | | | | | | | | | | |
| WR/W | 0.67 | 0.67 | 0.67 | 0.33 | 0.67 | 0.67 | 0.87 | 0.87 | 0.87 | 0.87 | 0.33 | 0.17 |
| LR/L | 0.4 | 0.4 | 0.4 | 0.4 | 0.8 | 0.6 | 0.8 | 0.8 | 0.2 | 0.2 | 0.8 | 0.2 |
| HR/H | 0.62 | 0.38 | 0.15 | 0.62 | 0.62 | 0.62 | 0.15 | 0.85 | 0.85 | 0.38 | 0.38 | 0.38 |
| RT/BT | 0.16 | 0.10 | 0.04 | 0.08 | 0.33 | 0.25 | 0.11 | 0.59 | 0.15 | 0.07 | 0.10 | 0.01 |
| Evaluation | Excel- | Excel- | Bad | Excel- | Bad | Excel- | Excel- | Bad | Excel- | Bad | Excel- | Bad |
| of handling | lent | lent | | lent | | lent | lent | | lent | | lent | |
| stability | | | | | | | | | | | | |

As shown in the Table, when a dimension ratio WR/W=0.33 to 0.87, a dimension ratio LR/L=0.2 to 0.8, a dimension ratio HR/H=0.15 to 0.85 and a volume ratio RT/BT=0.08 to 0.25 are satisfied for each of the blocks, the handling stability is excellent. The reason is that the relative size of the recess with the block is set within the range described above. More specifically, each of the blocks is properly deformed and the proper deformation generates a grip force. As a result, a traction performance and a sliding performance can be enhanced.

1. A low internal pressure pneumatic tire for running over an uneven ground in which a tread is provided with a plurality of blocks formed to be protruded outward in a radial direction,
wherein each of the blocks is formed to take a solid shape specified by a long side dimension W, a short side dimension L and a high side dimension H, and an outer peripheral surface of the block forming a tread surface is provided with a recess specified by a long side dimension WR, a short side dimension LR and a deep side dimension HR, there are set
WR/W=0.33 to 0.87,
LR/L=0.2 to 0.8, and
HR/H=0.15 to 0.85, and
a ratio of a block volume BT to a recess volume RT is set to be
RT/BT=0.08 to 0.25.
